(19) United States
(12) Patent Application Publication
(10) Pub. No.: US 2025/0262717 A1
(43) Pub. Date: Aug. 21, 2025

(54) LIGHTWEIGHT GEAR AND MANUFACTURING METHOD OF PAD DRESSER USING WATER JET

(71) Applicant: SAESOL DIAMOND IND. CO., LTD., Ansan-si (KR)

(72) Inventors: Jeong-Min Kim, Siheung-si (KR); Min-Su Lee, Ansan-si (KR)

(21) Appl. No.: 19/056,589

(22) Filed: Feb. 18, 2025

(30) Foreign Application Priority Data
Feb. 21, 2024 (KR) 10-2024-0025251
Dec. 18, 2024 (KR) 10-2024-0190050

(51) Int. Cl. B24B 53/12; B24B 53/017

(52) U.S. Cl. CPC B24B 53/12; B24B 53/017

(57) ABSTRACT

A method of manufacturing a lightweight pad dresser for a polishing device includes cutting a gear to have a gear thickness, and cutting a water jet cutting hole through the gear using a water jet. A first segment and a second segment, each having a segment plate thickness, are bonded together, and the first and second segments are attached to the gear within the water jet cutting hole. Manufacture of the lightweight pad dresser is completed while maintaining flatness of the gear. Lightweight pad dressers are formed using such methods. A lightweight gear of a lightweight pad dresser includes a gear ring, and first, second, and third inner rings separated from one another by water jet cutting holes. A segment fixing part integrates the gear ring and the first inner ring, and a ring joint integrates the first, second, and third inner rings.

### CROSS-REFERENCE TO RELATED APPLICATIONS

The present application claims priority to Korean Patent Application Serial Nos. KR 10-2024-0025251, filed Feb. 21, 2024 and KR 10-2024-0190050, filed Dec. 18, 2024, the entire disclosure of each of which is incorporated herein in its entirety by this reference.

### TECHNICAL FIELD

The present disclosure relates to a gear of a pad dresser, and more specifically, to a lightweight gear and manufacturing method of a pad dresser using a water jet, which enables a combination of a thin gear and a segment using a water jet and epoxy attachment and enables additional weight reduction by forming a hole in a thickness reduced in combination of the segment.

### BACKGROUND

In general, a wafer polishing process of a semiconductor polishing device is a chemical mechanical polishing process of combining mechanical removal processing and chemical removal processing into one processing method and includes wafer polishing of a polishing pad and dressing of a pad dresser.

For example, the pad dresser is comprised of a combination of a gear and a segment, the gear is rotatably engaged between inner/outer gears of the polishing device, and the segment is attached (e.g., coupled or fixed) to the gear to face a surface of the polishing pad, thereby removing glazing from the surface of the polishing pad.

To this end, the pad dresser is manufactured by the following procedure: 1) cutting a gear (e.g., a stainless steel (SUS) or poly-vinyl chloride (PVC) material) to be thick (e.g., a cross-section with a thickness of 9 to 15 T) (units: mm) and performing CNC cutting on a segment mounting portion->2) separately manufacturing a segment (e.g., a cross section with a thickness of 6 T)->3) screw-fastening and assembling the segment to the cut gear.

Accordingly, the dressing of the pad dresser removes the glazing of the polishing pad occurring during the polishing process, thereby preventing a polishing speed from slowing down by restoring the polishing pad to its original state. In this case, the glazing is a phenomenon in which pad debris, wafer abrasive residue, and slurry particles, which are generated due to friction between the polishing pad and the wafer, are stuck to the surface of the pad.

In particular, the pad dresser is referred to as a diamond dresser because it uses diamonds in a segment.

Typically, the gear has a size (e.g., an outer diameter of 432 mm/inner diameter of 365 mm/thickness of 10 to 18 mm) and a heavy weight (e.g., about 5 kg), which is inevitable because the gear needs to have a thickness of at least 9 T in order to prevent flatness distortion due to deformation of a material during CNC cutting.

However, in industrial sites, the weight of the gear is inevitably a major issue, which determines the ease of work in a process of replacing the pad dresser.

### BRIEF SUMMARY

Accordingly, considering such a point, the present disclosure is directed to providing a lightweight gear and manufacturing method of a pad dresser using a water jet, in which a segment attachment hole is formed in a gear through water jet cutting with less material deformation, a double-sided diamond segment positioned in a segment attachment hole with epoxy attachment is fixed to a gear and combined with the thin gear with a reduced weight, and in particular, due to the double-sided diamond segment, the life of the gear is longer in comparison to a one-sided diamond segment, and a plurality of rings are formed in a concentric structure through a plurality of holes formed in a thin and light gear, thereby enabling additional weight reduction.

To achieve the above object, according to an aspect of the present disclosure, there is provided a method of manufacturing a lightweight pad dresser using a water jet, which includes cutting a gear in a gear thickness that maintains flatness during water jet cutting, cutting a water jet cutting hole of the gear through the water jet cutting, bonding a first segment and a second segment and manufacturing the segment having a segment plate thickness, attaching the segment to the water jet cutting hole through epoxy attachment, and completing manufacture of the gear enabling double-sided dressing while maintaining flatness.

Preferably, the gear thickness is set to be ⅓ of a thickness required for CNC cutting.

Preferably, the water jet cutting hole is cut to pass through the gear and is formed as a plurality of water jet cutting holes along circle circumference of the gear. The segment plate thickness is a sum of a segment plate thickness of the first segment and a segment plate thickness of the second segment, and the segment plate thickness of the first segment is the same as the segment plate thickness of the second segment. Each of the first segment and the second segment has one surface coated with a diamond and the other surface without the diamond attached with an adhesive.

Preferably, the epoxy attachment is performed along an edge of a segment attachment hole.

Preferably, the flatness is of 100 μm or less.

In addition, to achieve the above object, according to another aspect of the present disclosure, there is provided a lightweight pad dresser using a water jet, which includes a gear having a plurality of water jet cutting holes having a predetermined size formed along a circumference of a circle and having a flatness of 100 μm or less, and a segment in which a diamond is exposed at both surfaces thereof while fixed to the water jet cutting hole through epoxy attachment, wherein the segment has a structure in which one surface of each of a first segment and a second segment are coated with the diamond and the other surfaces are bonded with an adhesive.

Preferably, the gear is made from an SUS or PVC material and formed in an annular ring shape, the water jet cutting hole is cut by a water jet in a gear edge width formed due to a diameter difference of an inner diameter and an outer diameter, and the water jet cutting hole has a structure passing through the gear and is formed as a plurality of water jet cutting holes along a circumference of a circle.

Preferably, the segment plate thickness of the first segment and the segment plate thickness of the second segment are the same, and each of the segment plate thicknesses is greater than or equal to the gear thickness.

In addition, to achieve the above object, according to still another aspect of the present disclosure, there is provided a lightweight gear of a pad dresser using a water jet, which includes a gear plate having first, second, and third inner rings formed through the water jet cutting holes inside a gear ring, a segment fixing part that integrates the first inner ring and the gear ring at a predetermined third angle, and a ring joint that integrates the second inner ring and the third inner ring with the first inner ring at a predetermined second angle, and the second angle is formed to be greater than the third angle.

Preferably, the ring joint and the segment fixing part have a linear shape, the third angle bisects the second angle, and the number of segment fixing parts is twice the number of ring joints.

In addition, to achieve the above object, according to yet another aspect of the present disclosure, there is provided a lightweight gear of a pad dresser using a water jet, which includes a gear plate having first, second, and third inner rings formed through the water jet cutting holes inside a gear ring, a segment fixing part that integrates the first inner ring and the gear ring at a predetermined fourth angle, and a ring joint that integrates the second inner ring and the third inner ring with the first inner ring at a predetermined fifth angle, and the fourth angle is formed to be greater than the fifth angle.

Preferably, the ring joint has a wedge shape by a front-end portion having a “V” shape and a base portion having a “U” shape, the segment fixing part has a linear shape, the number of segment fixing parts and the number of ring joints are the same, the front-end portion coincides with the fourth angle, and the base portion forms the fifth angle.

Preferably, the gear is coupled to a carrier to form a first exposure space and a second exposure space, the first exposure space is the water jet cutting hole of the gear plate, and the second exposure space is a space in which a wafer is positioned at a center point of the gear plate.

In addition, to achieve the above object, according to yet another aspect of the present disclosure, there is provided a lightweight gear of a pad dresser using a water jet, which includes a gear plate having first, second, and third inner rings formed through the water jet cutting holes inside a gear ring, a segment fixing part that integrates the first inner ring and the gear ring at a predetermined sixth angle, and a ring joint that integrates the second inner ring and the third inner ring with the first inner ring at a predetermined seventh angle, and the sixth angle is formed to be greater than the seventh angle.

Preferably, the ring joint has a wedge shape by a front-end portion having a “V” shape and a base portion having a “U” shape, the segment fixing part has a linear shape, the number of segment fixing parts is twice the number of ring joints, the front-end portion coincides with the sixth angle, and the base portion forms the seventh angle.

Preferably, the first, second, and third inner rings form a concentric structure with a center point of the gear plate inside the gear ring. The ring joint and the segment fixing part are radially arranged in a circumferential direction with respect to the gear center point of the gear plate.

Preferably, the water jet cutting hole is divided into an outer cutting hole, which forms the segment fixing part on the gear ring and the first inner ring, and an inner cutting hole, which forms the ring joint on the second inner ring and the third inner ring.

### BRIEF DESCRIPTION OF THE DRAWINGS

FIG. 1 is a flowchart of a gear manufacturing method of a lightweight pad dresser using a water jet according to the present disclosure.

FIG. 2 is an example of a structure of a gear and water jet cutting in the manufacturing method of a lightweight pad dresser according to the present disclosure.

FIG. 3 is an example in which the gear according to the present disclosure is manufactured as a lightweight gear through a plurality of gear rings and holes.

FIG. 4 is an example in which the lightweight gear according to the present disclosure has strengthened durability with the number of gear ring fixing parts.

FIG. 5 is an example in which the lightweight gear according to the present disclosure has strengthened durability with a width of the gear ring fixing part.

FIG. 6 is an example of epoxy attachment of a double-sided segment and a gear in the manufacturing method of a lightweight pad dresser according to the present disclosure.

FIG. 7 illustrates a state in which a pad dresser is manufactured as a double-sided diamond dresser by a combination of the gear and the segment according to the present disclosure.

FIG. 8 illustrates a state in which the double-sided diamond dresser according to the present disclosure is applied to a polishing device.

### DETAILED DESCRIPTION

Hereinafter, embodiments of the present disclosure will be described in detail with reference to the accompanying drawings, and these embodiments are examples and can be implemented in various different forms by those skilled in the art to which the present disclosure pertains, and thus are not limited to embodiments disclosed herein.

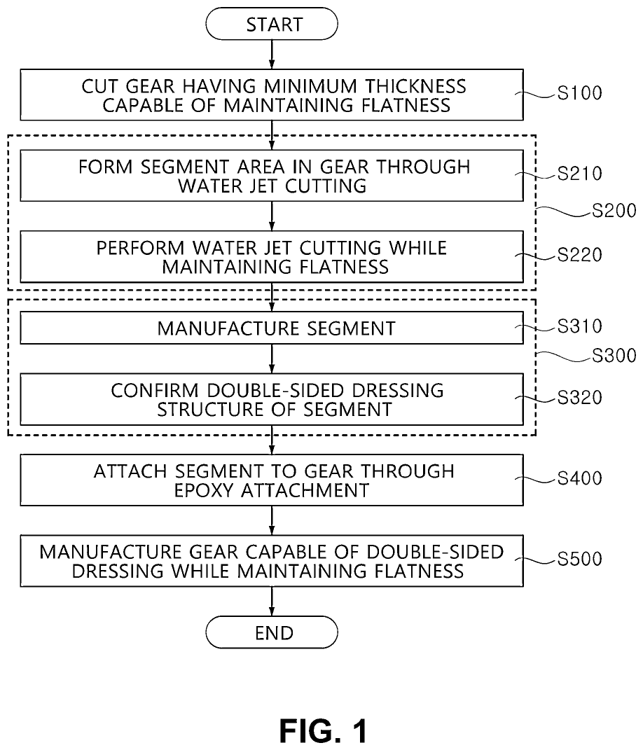

Referring to FIG. 1, a lightweight gear manufacturing method of a pad dresser using a water jet includes a gear preparing operation S100, a water jet cutting operation S200, a segment preparing operation S300, an epoxy attaching operation S400, and a pad dresser manufacturing operation S500.

Accordingly, the manufacturing method of a lightweight pad dresser is a manufacturing method of a lightweight pad dresser using water jet cutting and epoxy attachment, thereby enabling weight reduction of the pad dresser and weight reduction of a gear with an advantage of water jet cutting and, in particular, the pad dresser is a double-sided diamond dresser.

The gear preparing operation S100 is performed through cutting of a gear 200 having a minimum thickness capable of maintaining flatness.

The water jet cutting operation S200 enables additional weight reduction, by reducing a weight of a thin gear 200 in a concentric structure using a plurality of water jet cutting holes 230, and segment attachment holes are formed in the gear through water jet cutting as in operation S210, and the water jet cutting is performed while maintaining the flatness of the gear as in operation S220.

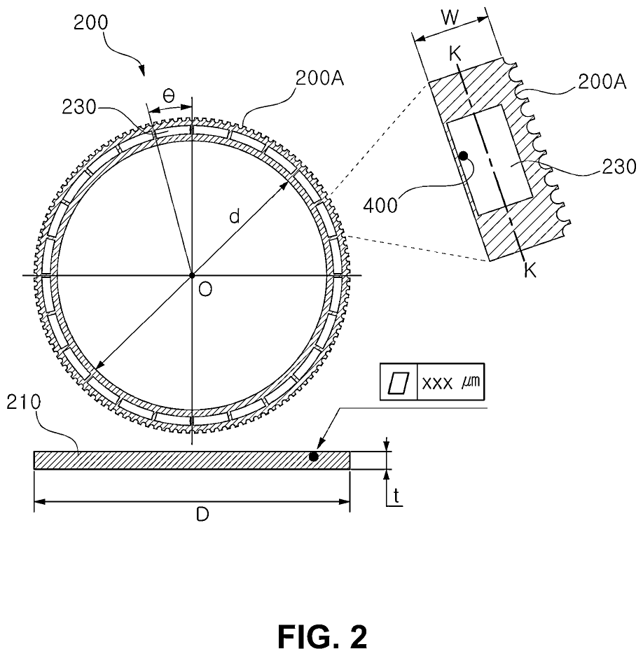

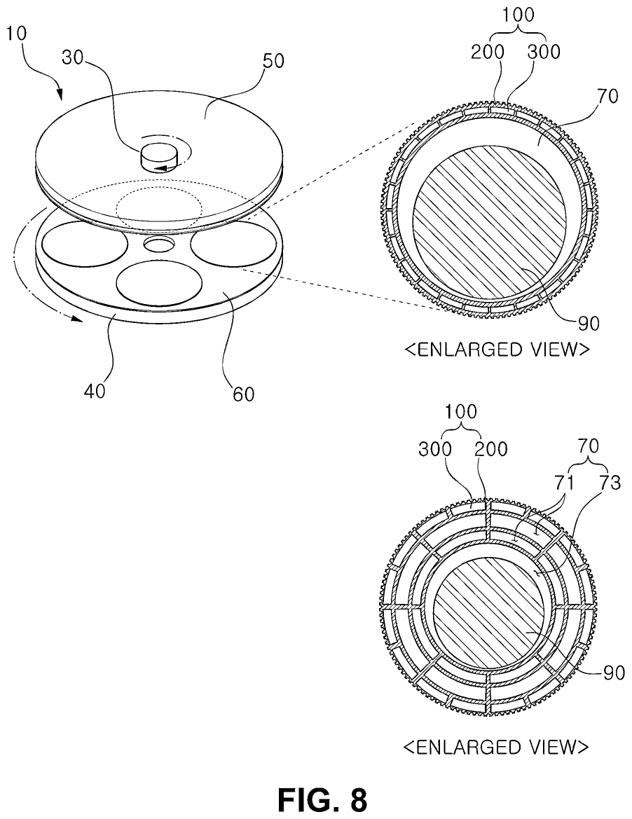

Referring to FIG. 2, the gear 200 is made from a stainless steel (SUS) or a poly-vinyl chloride (PVC) material and is formed as an annular ring-shaped gear plate 210 having a gear edge width W and a gear thickness t, and the gear plate 210 has gear ring 200A formed at an outer edge thereof to circumscribe each of inner/outer gears 30 and 40 (see FIG. 8) of a polishing device 10.

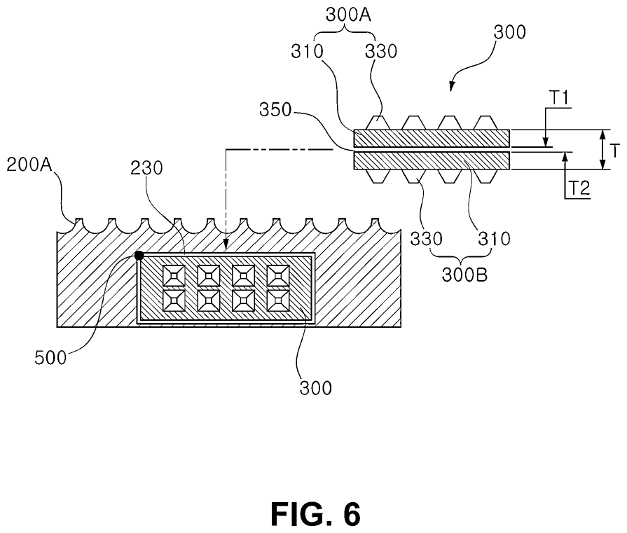

For example, the gear edge width W is formed as a diameter difference (D−d) between an inner diameter d and an outer diameter D of the annular ring shape to form a water jet cutting hole 230 to which a segment 300 (see FIG. 6) is attached, and the water jet cutting holes 230 are formed with the same size throughout the circumference by partitioning the 360° circumference of the gear 200 at a first acute angle θ. In this case, the outer diameter D may be about 432 mm, the inner diameter d may be about 365 mm, and the first angle θ may be set to 15° but may be set to a smaller or larger angle as needed.

Although the water jet cutting hole 230 is illustrated as a rectangle, in reality, it is formed in an arc shape corresponding to the first angle θ of about 15° out of a 360° circle, and the segment 300 (see FIG. 6) having the first angle θ is also the same.

In particular, the water jet cutting hole 230 is biased toward an interior of the gear with respect to a center line K-K of the gear edge width W and positioned close to the inner diameter d, thereby strengthening the durability of the gear ring 200A at the outer diameter D side, which are rotatably engaged with the rotation gears 30 and 40.

For example, the gear thickness t (units: mm) is set to a thickness that maintains flatness without distortion of the gear plate 210 even when the water jet cutting hole 230 is cut, and since the water jet cutting hole 230 is cut using a water jet cutting technology having less material deformation than computerized numerical control (CNC) cutting, the thickness of the water jet cutting is made smaller than the thickness required for the CNC cutting.

In particular, the gear 200 may be flat, which ensures process precision and high quality with uniform thickness for a wafer 90, and a set value of the flatness may be about 100 μm or less, but may be the same.

Accordingly, when the CNC cutting thickness is 100%, the gear thickness t is applied at a rate of about 30 to 40%, and preferably has a thickness of about ⅓. In this case, the CNC cutting thickness ranges from about 9 to 15 T, and the water jet cutting thickness may, for example, range from about 3 to 5 T.

In addition, the gear 200 may be manufactured as a lightweight gear in which additional weight reduction is implemented by forming a hole in a smaller thickness in combination of the segment 300.

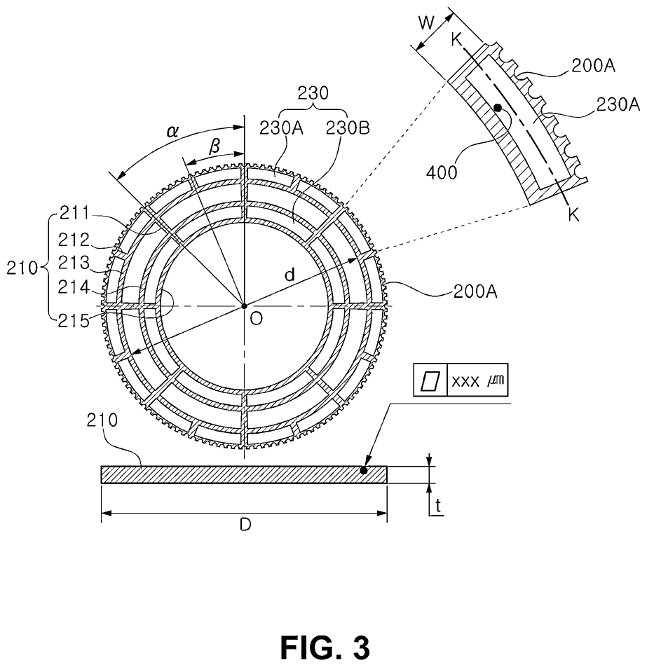

Referring to the lightweight gear of FIG. 3, the gear 200 is made from an SUS or PVC material and formed as the gear plate 210 in which three first, second, and third inner rings 213, 214, and 215 having a different size from the gear ring 200A are formed in a concentric structure through a plurality of water jet cutting holes 230.

The gear teeth of the gear ring 200A, which are formed on an outer circular edge, circumscribe each of the inner/outer gears 30 and 40 (see FIG. 8) of the polishing device 10, and the gear ring 200A, the first inner ring 213, the second inner ring 214, and the third inner ring 215 are spaced apart from each other.

The first, second, and third inner rings 213, 214, and 215 are three rings with different sizes and form a concentric structure with the gear ring 200A as an outermost portion in an internal space of the gear ring 200A.

Accordingly, the gear plate 210 includes ring joints 211 and segment fixing parts 212, which integrate the gear ring 200A with the first, second, and third inner rings 213, 214, and 215, the ring joint 211 forms a gap between inner cutting holes 230B among the water jet cutting holes 230 to integrate the first, second, and third inner rings 213, 214, and 215 with the gear ring 200A, and the segment fixing part 212 forms a gap between outer cutting holes 230A among the water jet cutting holes 230 to bisect the ring joint 211 and integrate the first inner ring 213 with the gear ring 200A.

That is, the ring joint 211 and the segment fixing part 212 are arranged radially in a circumferential direction with respect to a gear center point O of the gear plate 210, the ring joint 211 forms a predetermined second angle a with respect to the gear center point O, and the segment fixing part 212 is positioned between two adjacent ring joints 211 at a predetermined third angle β with respect to the gear center point O to bisect the second angle α. In this case, since the second angle α is set to about 45°, the third angle β may be set to about 22.5°.

In addition, among the water jet cutting holes 230, the outer cutting hole 230A may be used as a segment attachment hole to attach the segment 300, and the inner cutting hole 230B may be cut as an additional weight reduction hole to reduce the weight of the gear 200 but may be used as a segment attachment hole to attach the segment 300 as needed.

In addition, the gear 200 forms the gear edge width W of the gear ring 200A and the first inner ring 213 by a diameter difference (D−d) between the outer diameter D of the gear ring 200A and the inner diameter d of the first inner ring 213 and forms gear edge widths of the second and third inner rings 214 and 215 by a diameter difference between an outer diameter of the second inner ring 214 and an inner diameter of the third inner ring 215.

Accordingly, the gear edge width W may allow the outer cutting hole 230A and the inner cutting hole 230B of the water jet cutting hole 230 to form in an arc shape, and the outer cutting hole 230A is biased toward the interior of the gear with respect to the center line K-K of the gear edge width W and close to the inner diameter d, thereby strengthening the durability of the gear teeth at the outer diameter D side, which are rotatably engaged with the inner/outer gears 30 and 40 (see FIG. 8).

In addition, the gear 200 may be set to the gear thickness t, which maintains flatness without distortion of the gear plate 210 even when the water jet cutting hole 230 is cut, and in the case of the gear thickness t, the thickness of water jet cutting may be set to be smaller than the thickness required for CNC cutting because the water jet cutting hole 230 to which the segment 300 is attached may be cut by the technology of the water jet cutting 400, which has less material deformation in comparison to CNC cutting, and the flatness may be set to flatness (e.g., 100 μm or less), which ensures process precision and high quality with uniform thickness for the wafer 90.

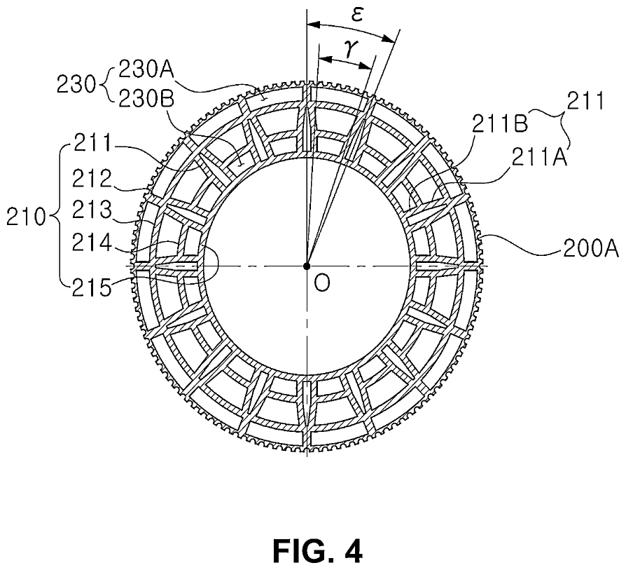

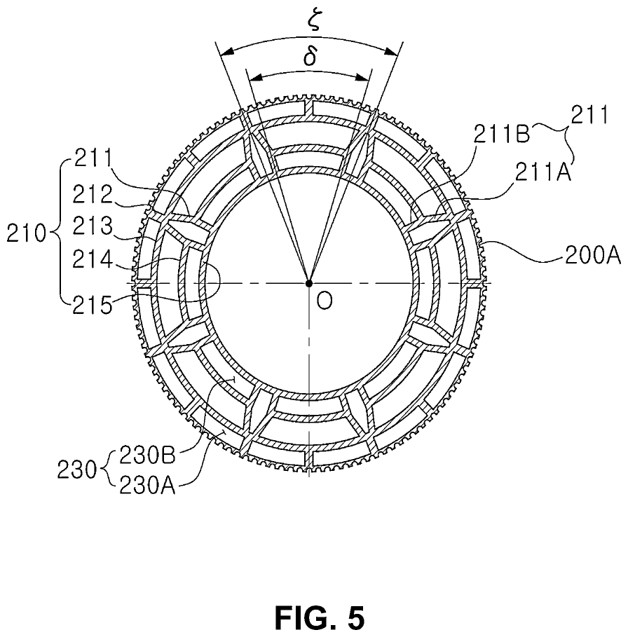

Meanwhile, in the lightweight gear of FIG. 3, as illustrated in FIGS. 4 and 5, the durability of the first, second, and third inner rings 213, 214, and 215 of the gear 200 can be strengthened by a change in structure of the ring joint 211.

Referring to the lightweight gear with strengthened durability of FIG. 4, the gear 200 has a structure in which the gear plate 210 is comprised of the gear ring 200A and the first, second, and third inner rings 213, 214, and 215, the ring joints 211, and the segment fixing parts 212, which are a concentric structure, when compared to the case of FIG. 3, and the shape and number of ring joints 211 differ from those of FIG. 3, and thus the durability of the gear 200 is strengthened.

That is, the number of ring joints 211 and the number of segment fixing part 212 are formed at a ratio of 1:1, and the ring joints 211 are positioned at the same positions as the segment fixing parts 212 to form a fourth angle ε and have a wedge shape with a greater width than the uniform width of the straight shape of the segment fixing parts 212. In this case, the fourth angle ε may be the same as the third angle β.

The wedge shape of the ring joints 211 is divided into a pointed front-end portion 211A and a wide base portion 211B, and the pointed shape of the front-end portion 211A gradually narrows in width to match the formation point of the segment fixing part 212 so that a first exposure space 71 between the first inner ring 213 and the second inner ring 214 has a “V” shape in which a carrier is exposed, and the wide “U” shape of the base portion 211B has a space (i.e., the inner cutting hole 230B) between the second inner ring 214 and the third inner ring 215 with a constant width.

Accordingly, the ring joint 211 forms an overlapping angle (ε, γ) of the fourth angle ε and the fifth angle γ with respect to the gear center point O of the gear plate 210, the fourth angle ε is an angle formed by the front-end portion 211A of the ring joint 211, which coincides with the segment fixing part 212, and the fifth angle γ is an angle formed by two adjacent base portions 211B at an angle smaller than the fourth angle ε due to the width of the base portion 211B.

Accordingly, the fifth angle γ is smaller than the fourth angle ε.

Referring to the lightweight gear with strengthened durability of FIG. 5, the gear 200 has a structure in which the gear plate 210 is comprised of the gear ring 200A and the first, second, and third inner rings 213, 214, and 215, the ring joints 211, and the segment fixing parts 212, which are a concentric structure, when compared to the case of FIG. 3, but the ring joint 211 maintains the wedge shape formed by the front-end portion 211A and the base portion 211B, and the number of ring joints 211 is reduced in comparison to the case of FIG. 4, and thus there is a difference in that focus is on ease of manufacturing rather than strengthening the durability of the gear 200.

That is, the number of ring joint 211 and the number of segment fixing part 212 are formed at a ratio of 1 to 2 and thus the number of ring joints 211 is reduced to half (i.e., ½) in comparison of FIG. 4, and the ring joint 211 forms an overlapping angle (ζδ) of a sixth angle ζ and a seventh angle δ with respect to the gear center point O of the gear plate 210. In this case, the sixth angle ζ may be the same as the second angle α.

Accordingly, the sixth angle ζ is an angle formed by the front-end portion 211A of the ring joint 211, which coincides with the segment fixing part 212, and the seventh angle δ is an angle formed by two adjacent base portions 211B at an angle smaller than the sixth angle ζ due to the width of the base portion 211B.

Accordingly, the seventh angle δ is smaller than the sixth angle ζ.

Accordingly, in FIGS. 2 to 5, an angular size relationship between the first angle θ, the second angle α, the third angle β, the fourth angle ε, the fifth angle γ, the sixth angle ζ, and the seventh angle δ decreases from α and ζ to θ, such as “α, ζ>δ>β, ε>γ>θ.”

Again, in the segment preparing operation S300 of FIG. 1, the segment manufacturing of operation S310 includes confirming a double-sided dressing structure of the segment of operation S320, and the epoxy attaching operation S400 includes attaching the segment 300 to the gear 200 through epoxy.

Referring to FIG. 6, the segment 300 may have a pair of first and second segments 300A and 300B adhered with an adhesive 350, and each of the first and second segments 300A and 300B may have the size and shape fitted into the outer cutting hole 230A of the water jet cutting hole 230 and may be characterized as a double-sided diamond segment that simultaneously polishes upper and lower polishing pads 50 and 60.

The first and second segments 300A and 300B are composed of the first segment 300A and the second segment 300B adhered via the adhesive 350, and each of the first segment 300A and the second segment 300B is formed as the segment plate 310 having one surface having a diamond 330 coated with polishing particles and an opposite surface coated with the adhesive 350 in a segment plate thickness T (units: mm).

Accordingly, the segment plate thickness T is formed by the sum (T1+T2) of an segment plate thickness T1 of the first segment 300A and a segment plate thickness T2 of the second segment 300B and the adhesive between the upper and lower segments, and each of the segment plate thickness T1 of the first segment 300A and the segment plate thickness T2 of the second segment 300B is greater than the gear thickness t but may be applied as the same thickness.

Subsequently, the segment 300 is fixed with epoxy attachment 500 while fitted into the segment attachment hole 230 of the gear 200, and the epoxy attachment 500 is performed along an edge of the segment attachment hole 230. In this case, when the epoxy attachment 500 is performed, care is taken so that the diamond 330 of the first segment 300A and the diamond 330 of the second segment 300B protrude evenly from the gear thickness t of the gear 200.

Finally, the pad dresser manufacturing operation S500 is an operation of completing the manufacture of the gear capable of double-sided dressing while maintaining the flatness as the final flatness.

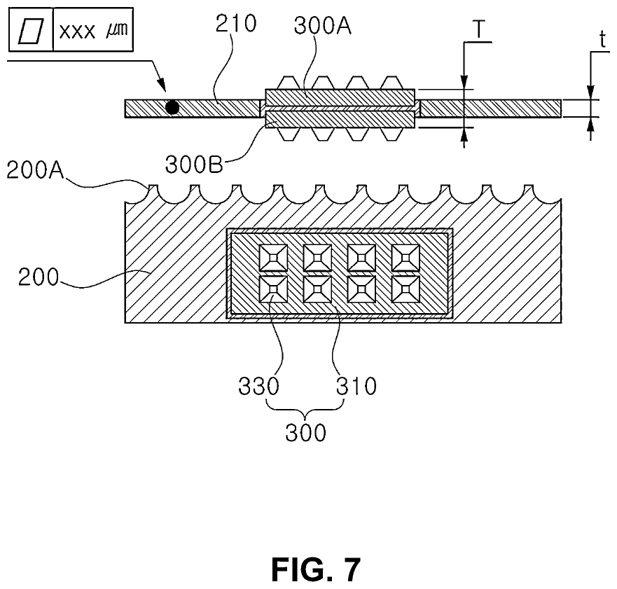

Referring to FIG. 7, the gear 200 forms a double-sided dressing structure in which the diamonds 330 of the first and second segments 300A and 300B protrude from the upper and lower surfaces with the gear thickness t, which is smaller than the segment plate thickness T of the segment 300, and such a double-sided dressing structure is characterized in that the pad dresser 100 is a double-sided diamond dresser.

In particular, the pad dresser 100 is manufactured while maintaining the flatness of the gear 200 of about 100 μm, which is within or equal to a set value of the final flatness, thereby ensuring process precision and high quality with uniform thickness for the wafer 90.

In addition, the bonding strength between the segment 300 and the gear 200 is equal to or greater than the bonding strength between the first and second segment 300A and 300B capable of maintaining polishing even when detached because they are mounted by being inserted into the water jet cutting holes 230 during polishing, and the reason is that the polishing function is lost when both the first and second segments 300A and 300B are detached from the water jet cutting hole 230.

Meanwhile, referring to FIG. 8, the polishing device 10 includes the inner/outer gears 30 and 40, the polishing pads 50 and 60, and the pad dresser 100 combined with the carrier 70 on which the wafer 90 is positioned.

That is, the polishing device 10 is composed of the inner gear 30 for rotating the upper polishing pad 50 clockwise using motor power, the outer gear 40 for rotating the lower polishing pad 60 counterclockwise using motor power, and the carrier 70 on which the wafer 90 polished through rotation in opposite directions and friction between the upper and lower polishing pads 50 and 60 is positioned, and since the components 30, 40, 50, 60, and 70 are known components of the polishing device 10, detailed description thereof will be omitted.

However, the polishing device 10 may include the pad dresser 100.

The pad dresser 100 of FIG. 2 is composed of a combination of the gear 200 and the segment 300, the gear 200 is positioned between the inner gear 30 and the outer gear 40 in an annular ring shape and rotatably engaged with the gears 30 and 40 through the gear ring 200A at the outer diameter side, and the segment 300 is provided as a plurality of segments having a predetermined size and arranged around a 360° circle of the gear 200.

The pad dresser 100 of FIGS. 3 to 5 enables additional weight reduction of the gear plate 210 because the water jet cutting holes 230 formed in the gear plate 210 to couple the gear 200 to the segment 300 is formed to include both the outer cutting hole 230A and the inner cutting hole 230B.

In addition, the gear 200 is coupled to the carrier 70 to form a first exposure space 71 and a second exposure space 73, the first exposure space 71 is the water jet cutting hole 230 of the gear plate 210, and the second exposure space 73 is a space in which the wafer 90 is positioned at the center point of the gear plate 210.

Accordingly, the water jet cutting hole 230 is divided into the outer water jet cutting hole 230A of the gear ring 200A and the first inner ring 213, and the inner water jet cutting hole 230B of the second inner ring 214 and the third inner ring 215, thereby enabling additional weight reduction of the gear plate 210, and is formed as the first exposure space 71.

Accordingly, each of the pad dressers 100 of FIGS. 2 and 3 to 5 removes pad glazing in which pad debris, wafer abrasive, residue, and slurry particles are stuck to the upper/lower polishing pads 50 and 60 during the polishing process of the wafer 90 and returns the pads to their original states to maintain the polishing speed, thereby enabling the wafer 90 to have flatness, which is deeply involved in wafer efficiency and process stability.

In addition, the pad dresser 100 is a double-sided pad dresser manufactured by the manufacturing method of a lightweight pad dresser using water jet cutting and epoxy attachment and is composed of a pair of first and second segments 300A and 300B (see FIG. 6) each having a particle row of the diamonds 330, thereby enabling simultaneous pad glazing removal for the upper polishing pad 50 of the first segment 300A and the lower polishing pad 60 of the second segment 300B.

Accordingly, the pad dresser 100 eliminates fine damage from scratches or particles caused by pad glazing through simultaneous double-sided polishing using the structural features of the double-sided pad dresser and provides excellent flatness to the wafer 90, thereby ensuring process precision and high quality with uniform thickness, and is particularly suitable for ultra-thin silicon wafers and micro-electromechanical systems (MEMS) elements for which double-sided polishing is essential.

As described above, in the lightweight gear 200 of the pad dresser using the water jet according to the present embodiment, the 360° circumference of the gear 200 may be divided at the first acute angle θ by the water jet cutting holes 230, or in the lightweight gear 200, the first, second, and third inner rings 213, 214, and 215 formed by the water jet cutting holes 230 form a concentric structure with the gear ring 200A, the second angle a of the ring joint 211, which integrates the first, second, and third inner rings 213, 214, and 215, includes the third angle β of the segment fixing part 212, which integrates the first inner ring 213 with the gear ring 200A, the fourth angle ε includes the fifth angle γ formed by the wedge shape of the ring joint 211, or the sixth angle ζ includes the seventh angle δ formed by the wedge shape of the ring joint 211, and the additional lightweight of the thin gear 200 is achieved through the concentric structure formed by the water jet cutting holes 230 in combination of the segment 300.

According to the lightweight gear and manufacturing method of the pad dresser using the water jet cutting of the present disclosure, since the gear with the same size (e.g., an outer diameter of 432 mm/inner diameter of 365 mm) is used and the gear has the thickness of about ⅓ T and the weight of about ⅓, handling is easy, thereby providing ease of work during the replacing process, and in particular, since the double-sided segment is combined with the gear, the life can be extended twice in comparison to the combination of the one-sided segment and the gear.

In addition, according to the lightweight gear and manufacturing method of the pad dresser using the water jet cutting of the present disclosure, it is possible to provide ease of handling and replacement work due to the smaller thickness and lighter weight than before, and in particular, the plurality of rings are formed in the concentric structure through the plurality of holes formed in the thin and light gear, thereby enabling additional weight reduction.

What is claimed is:

1. A method of manufacturing a lightweight pad dresser for a polishing device using a water jet, comprising:
cutting a gear to have a gear thickness capable of maintaining flatness during water jet cutting;
cutting a water jet cutting hole of the gear using a water jet;
bonding a first segment and a second segment together, each of the first segment and the second segment having a segment plate thickness;
attaching the first segment and the second segment to the gear within the water jet cutting hole using epoxy; and
completing manufacture of the lightweight pad dresser while maintaining flatness of the gear.

2. The method of claim 1, wherein the segment plate thickness is a sum of a segment plate thickness of the first segment and a segment plate thickness of the second segment and is greater than the gear thickness of the gear.

3. The method of claim 1, wherein cutting the water jet cutting hole comprises cutting a plurality of water jet cutting holes along a circumference of a circle, each water jet cutting hole of the plurality passing through the gear.

4. The method of claim 1, wherein each of the first segment and the second segment has one surface coated with a diamond.

5. The method of claim 1, wherein attaching the first segment and the second segment to the gear within the water jet cutting hole using epoxy comprises bonding the first segment and the second segment to the gear along an edge of the water jet cutting hole using the epoxy.

6. A lightweight pad dresser for a polishing device, comprising:
a gear having a plurality of water jet cutting holes formed along a circumference of a circle; and
a segment structure fixed to the gear within each water jet cutting hole of the plurality, each segment structure having a diamond exposed on opposing surfaces thereof;
wherein each segment structure includes a first segment and a second segment bonded together, each of the first segment and the second segment having one surface coated with the diamond.

7. The lightweight pad dresser of claim 6, wherein the gear comprises a stainless steel (SUS) or a poly-vinyl chloride (PVC) material and has an annular ring shape; and
wherein each water jet cutting hole of the plurality of water jet cutting holes is cut by a water jet in a gear edge width defined as a difference between an inner diameter and an outer diameter of the gear.

8. The lightweight pad dresser of claim 7, wherein each water jet cutting hole extends entirely through the gear.

9. The lightweight pad dresser of claim 6, wherein the gear includes:
a gear ring comprising a stainless steel (SUS) or a poly-vinyl chloride (PVC) material and having an annular ring shape;
a gear plate having first, second, and third inner rings separated from one another by additional water jet cutting holes;
a segment fixing part that integrates the gear ring and the first inner ring; and
a ring joint that integrates the first inner ring, the second inner ring, and the third inner ring.

10. The lightweight pad dresser of claim 9, wherein the first, second, and third inner rings form a concentric structure with a center point of the gear plate, and
the ring joint and the segment fixing part are radially arranged in a circumferential direction with respect to the center point of the gear plate.

11. The lightweight pad dresser of claim 9, wherein the gear is coupled to a carrier to form a first exposure space and a second exposure space, and
the first exposure space is defined by the additional water jet cutting holes, and the second exposure space is defined within the third inner ring.

12. The lightweight pad dresser of claim 11, wherein a first plurality of the additional water jet cutting holes are disposed between the gear ring and the first inner ring, and a second plurality of the additional water jet cutting holes are disposed between the second inner ring and the third inner ring.

13. The lightweight pad dresser of claim 6, wherein, a bond strength between the segment structure and the gear within each water jet cutting hole is greater than a bond strength between the first segment and the second segment.

14. A lightweight gear of a pad dresser for a polishing device, comprising:
a gear ring comprising a stainless steel (SUS) or a poly-vinyl chloride (PVC) material and having an annular ring shape;
a gear plate having first, second, and third inner rings separated from one another by water jet cutting holes;
a segment fixing part integrating the gear ring and the first inner ring; and
a ring joint including a front-end portion and a base portion, the ring joint integrating the first inner ring, the second inner ring, and the third inner ring.

15. The lightweight gear of claim 14, wherein the front-end portion and the base portion form a wedge shape, and
the segment fixing part forms a linear shape.

16. The lightweight gear of claim 15, wherein the front-end portion has a “V” shape, the base portion has a “U” shape, and
the wedge shape is formed by the combination of the “V” shape and the “U” shape.

17. The lightweight gear of claim 14, wherein the ring joint and the segment fixing part are connected.

18. The lightweight gear of claim 14, wherein the number of segment fixing parts is twice the number of ring joints.

19. The lightweight gear of claim 14, wherein the first, second, and third inner rings form a concentric structure with a center point of the gear plate, and
the front-end portion, the base portion, and the segment fixing part are radially arranged in a circumferential direction with respect to the center point of the gear plate.

20. The lightweight gear of claim 14, wherein the water jet cutting holes include a first plurality of water jet cutting holes disposed between the gear ring and the first inner ring, and a second plurality of water jet cutting holes disposed between the second inner ring and the third inner ring.
